(19) United States
(12) Patent Application Publication
(10) Pub. No.: US 2024/0181926 A1
(43) Pub. Date: Jun. 6, 2024

(54) EXTERNAL ENERGY TRANSFER TACTICS FOR HEAVY-DUTY VEHICLES

(71) Applicant: Volvo Truck Corporation, Göteborg (SE)

(72) Inventors: Anders MAGNUSSON, Göteborg (SE); Leo LAINE, Göteborg (SE); Johan LINDBERG, Göteborg (SE); Linus NORDHOLM, Askim (SE); Jens SAMSIOE, Sävedalen (SE); Oscar KLINTENBERG, Göteborg (SE)

(21) Appl. No.: 18/286,650

(22) PCT Filed: Mar. 17, 2022
(86) PCT No.: PCT/EP2022/057057

§ 371 Date: Oct. 12, 2023

(30) Foreign Application Priority Data
Apr. 16, 2021 (SE) 21504766

(51) Int. Cl. B60L 55/00; B60L 53/30; B60L 58/30

(52) U.S. Cl. CPC B60L 55/00; B60L 53/305; B60L 58/30; B60L 2200/36; B60L 2240/70

(57) ABSTRACT

A control system arranged to control transfer of energy to and from a heavy-duty vehicle, wherein the control system implements an application programming interface, API, configured to allow connections between control modules of the heavy duty vehicle and/or from one or more external entities to the vehicle wherein the control system is configured to determine an available amount of energy for transfer from the vehicle to an external consumer, and/or a desired amount of energy to transfer to the vehicle from an external energy source, wherein the control system is configured to exchange information related to the available amount of energy for transfer from the vehicle via the API, and wherein the control system is configured to exchange information related to the available amount of energy for transfer to the vehicle via the API.

### TECHNICAL FIELD

The present disclosure relates to control systems, methods, control units and computer architectures for safe, reliable and efficient transfer of energy to and from an electrically powered heavy-duty vehicle. The disclosed techniques are particularly suitable for use with articulated vehicles, such as trucks and semi-trailers comprising a plurality of vehicle units. However, the invention can also be applied in other types of heavy-duty vehicles, e.g., in construction equipment, forestry vehicles, and in mining vehicles.

### BACKGROUND

Traditional heavy-duty vehicles for cargo transport have primarily been powered by combustion engines run on diesel fuel. However, other types of energy sources for powering heavy-duty vehicles are being introduced at a high pace, such as batteries and/or fuel cell stacks for powering fully electric and hybrid electric heavy-duty vehicles. Hydrogen internal combustion engines are also more and more frequently used for propulsion.

With the introduction of electric vehicles, more options to transfer energy to the vehicle from energy sources in its surrounding environment, and also from the vehicle back to the energy sources, have arisen. For instance, unused electrical energy stored in a vehicle can be fed back into the power grid where it can be used for other purposes, or to other vehicles in need of extra energy. These options give rise to possible synergy effects, where advantages may be obtained if the energy transfer of more than one vehicle is considered jointly with the energy needs of other consumers in the system. However, there are also more options related to the energy transfer, which implies an increased complexity in handling decisions regarding energy transfer to and from the vehicle.

US 2015/0134188 relates to systems and methods for managing a fleet of electric vehicles. A fleet management portal is described which facilitates electrical energy transfer involving the fleet of vehicles.

WO 2018/098400 describes a multi-layer electric vehicle energy management system which describes improved charging systems for electrically powered vehicles.

US 2010/0049639 discloses an energy transaction broker system which facilitates electric energy charging transactions in vehicular applications.

However, despite the progress to-date there is a continuing need for further improvements in energy transfer mechanisms involving heavy-duty electrically powered vehicles.

### SUMMARY

It is an object of the present disclosure to provide techniques which provide safe and efficient energy transfer involving one or more heavy-duty vehicles. This object is at least in part obtained by a control system for a heavy-duty vehicle, wherein the control system is arranged to obtain information about an energy transfer and/or power transfer capability of the vehicle, obtain information related to a transport mission, and obtain information related to one or more power sources and/or one or more power consumers in the vehicle environment. The control system is arranged to determine tactics for when to transfer energy to or from the vehicle in dependence of the energy transfer capability of the vehicle, the upcoming transport mission, and the one or more power sources and/or one or more power consumers in the vehicle environment, where the tactics are determined under a constraint to fulfil the upcoming transport mission. The control system is also arranged to trigger transfer of energy to or from the one or more power sources and/or the one or more power consumers in the vehicle environment in accordance with the determined tactics.

The control systems described herein provide software-based monitoring and controlling functionality that is implemented in order to make near term tactical decisions about how and when to transfer the right amount of energy from an external energy supplier (source) to an ego vehicle and to transfer the right amount of energy from the ego vehicle (source) to an external energy consumer. The energy transfer control systems disclosed herein make use of vehicle environment data to determine energy transfer tactics, and to trigger the actual transfer of energy in accordance with the tactics.

The control systems disclosed herein are preferably implemented as part of a layered control system, where a higher layer control function makes more long terms decisions of how to handle energy transfer, and where lower layers determine more short-term strategies for energy transfer. The energy management control systems disclosed herein resemble vehicle motion control systems, where a higher layer performs route planning, i.e., more long-term strategies for vehicle motion control, and a vehicle motion management function then realizes the strategies by performing more short-term control of the vehicle in accordance with the long-term strategy. It is an advantage that the control systems disclosed herein allow joint architecture for vehicle motion management and vehicle energy management, using interfaces and processing resources which are used for both vehicle motion management and vehicle energy management.

The herein disclosed control systems are also applicable together with fuel cell powered vehicles. Thus, when transferring electricity from an electric power grid together with utilizing plain water from a water grid a vehicle having a hydrogen generating capability can generate hydrogen on-demand for use by the vehicle and also by other energy consumers. Generated hydrogen may be transferred to an external hydrogen storage or to hydrogen tanks on the vehicle.

According to aspects, the energy transfer capability comprises an energy storage system (ESS) state of charge (SOC) with respect to full charge, and the energy transfer capability is determined at least in part as a function of the ESS SOC. This means that the control system keeps track of how much energy that can be received or output by the ESS, and determines the energy transfer capability based on this SOC. The energy transfer capability may also comprise a fill level of a hydrogen tank on the vehicle. Thus, the control system can be arranged to take hydrogen tank fill state into account when determining energy transferring tactics and triggering energy transfer to or from the vehicle. Similar to a layered vehicle motion management control system, lower layer functions report capabilities to higher layer functions which are then able to adapt energy management strategies in dependences of the reported capabilities.

According to aspects, the transport mission is any of an ongoing transport mission or an upcoming transport mission. The energy transfer tactics may be planned in advance, and/or updated continuously in dependence of changes in vehicle environment.

According to some aspects, the information related to the transport mission comprises any of a driving schedule, a transportation order, and/or an itinerary. According to other aspects, the information related to the upcoming transport mission comprises information related to a projected load of the vehicle as function of time. According to further aspects, the information related to the upcoming transport mission comprises information related a road property. These different types of information are often applicable also for vehicle motion management, i.e., in planning vehicle routes by higher layer control functions and planning vehicle motion actuator requests at lower layer vehicle control functions. Thus, there are synergies which can be exploited with advantage if vehicle energy management control architecture is implemented together with vehicle motion control architecture.

According to aspects, the information related to the one or more power sources and/or the one or more power consumers in the vehicle environment comprises a cost associated with the transferred energy. This allows for cost optimization, which is an advantage. The total cost of different energy transfer tactics can be compared, and an energy transfer tactic associated with reduced cost can be selected in favor of a tactic associated with increased cost. The cost can be a monetary cost, or some other form of cost metric, such as a time spent during energy transfer, an environmental impact, or the like.

According to aspects, the control system is arranged to detect an unwanted and/or unauthorized transfer of energy to or from the vehicle. This allows a fleet operator or driver to prevent unauthorized energy transfer from the vehicle, or even to the vehicle if some energy sources are undesired. For instance, a given energy source may be associated with an increased convenience for a driver, but also an increased cost. The fleet operator may then use the control systems disclosed herein to detect if a driver uses an unauthorized energy source in favor of a preferred energy source.

According to aspects, the control system is arranged to prepare a fuel cell system of the vehicle for freezing, where the preparation comprises flushing the fuel cell system if the vehicle is in a location suitable for flushing the fuel cell system. Fuel cell systems may be damaged if frozen unprepared. The control systems disclosed herein may optionally make use of the vehicle environment system to check if there is a risk or freezing, i.e., by consulting a weather report or the like. If there is a risk for freezing, then the vehicle control system can determine if the fuel cell system can be safely flushed in preparation for freezing, or if the vehicle is in a location where flushing is not allowed, i.e., in an indoor location.

According to aspects, the control system is configured to report a current energy transfer capability of the vehicle and/or a set of energy types which can be transferred to and from the vehicle, in response to a request from an external entity. This way an interface is provided which can be used by operators, technicians, and third parties to interface with the vehicle and request information about the energy transfer capabilities of the vehicle.

According to aspects, the control system is configured to prevent vehicle motion during time periods when energy is transferred to or from the vehicle. This feature increases vehicle safety, since vehicle motion during energy transfer may be associated with risk.

There is also disclosed herein a control system arranged to control transfer of energy to and from a heavy-duty vehicle, wherein the control system implements an application programming interface (API) configured to allow connections between control modules of the heavy duty vehicle and/or from one or more external entities to the vehicle, wherein the control system is configured to determine an available amount of energy for transfer from the vehicle to an external consumer, and/or a desired amount of energy to transfer to the vehicle from an external energy source, wherein the control system is configured to exchange information related to the available amount of energy for transfer from the vehicle via the API, and wherein the control system is configured to exchange information related to the available amount of energy for transfer to the vehicle via the API.

This API facilitates control vehicle energy transfer in an efficient and robust manner. Advantageously, the API can be configured to support transfer of information related to vehicle motion management jointly with the transfer of information related to vehicle energy transfer. This way, vehicle energy transfer management can become an integrated part of the overall vehicle control, since vehicle motion management and vehicle energy transfer now can be integrated into the same control architecture, which is an advantage.

According to aspects, the control system is configured to maintain a list of energy types available for transfer to and/or from the vehicle, and to exchange information related to the energy types via the API. This means that modules can communicate capabilities regarding different energy types, which is an advantage.

According to aspects, the control system is configured to transmit a request for transfer of energy to the vehicle via the API. This request can then be treated in a manner similar to a motion request, and handled in the same type of control architecture, which is an advantage.

According to aspects, the control system is configured to exchange information related to a cost of energy via the API. This allows the system to perform cost optimization. The involved cost may be configured to reflect monetary cost, and also other types of cost such as environmental impact via, e.g., carbon dioxide emission and the like, as well as the time spent in transferring energy. It is an advantage that different types of cost can be considered, since it allows, e.g., an operator to optimize a transport mission according to a set of optimization criteria which are currently deemed most important.

According to aspects, the control system is configured to exchange information related to an energy transferring capability and/or energy transferring status with a transportation planning function via the API. This energy transferring capability and/or energy transferring status can be communicated using the same formats and message passing strategies as a vehicle motion management command, such as a request for acceleration or the like. It is an advantage that the vehicle energy transferring tactics can be integrated into the same control structure as the overall vehicle motion management and use the same communications resources and processing resources as he vehicle motion management functionality.

According to aspects, the control system is configured to exchange information related to location and type of power suppliers in the infrastructure via the API. This information exchange allows for vehicle energy transfer management based on vehicle environment features such as available power sources and sinks, which is an advantage. It is also an advantage to keep an up-to-date information about vehicle environment which can be used to determine suitable energy transfer tactics.

As mentioned above, the control system may also be arranged to detect an unwanted and/or unauthorized transfer of energy to or from the vehicle and to trigger transmission of a message indicating the unwanted and/or unauthorized transfer of energy via the API.

According to aspects, the control system is arranged to prepare a fuel cell system of the vehicle for freezing, where the preparation comprises flushing the fuel cell system, where the control system is arranged to communicate a status message indicating that the fuel cell system is ready for freezing via the API. Thus, the API provides a convenient means for verifying that the fuel cell system is ready for freezing, which is an advantage.

The control systems discussed herein may also be configured to prevent vehicle motion during time periods when energy is transferred to or from the vehicle, where the control system is arranged to communicate a status message indicating that motion by the vehicle is prevented due to ongoing energy transfer via the API.

There is also disclosed herein methods, computer programs, computer readable media, computer program products, and vehicles associated with the above discussed advantages.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

With reference to the appended drawings, below follows a more detailed description of embodiments of the invention cited as examples. In the drawings:

FIG. 1 schematically illustrates a heavy-duty vehicle for cargo transport;

FIG. 2 shows a layered control architecture for controlling a heavy-duty vehicle;

FIG. 3 illustrates example functional dependencies in a vehicle control system;

FIGS. 4-5 are flow charts illustrating example methods of the present disclosure;

FIG. 6 schematically illustrates a sensor unit and/or a control unit for a control system;

FIG. 7 shows an example computer program product; and

FIG. 8 illustrates some example vehicle operating conditions.

### DETAILED DESCRIPTION OF EXAMPLE EMBODIMENTS OF THE INVENTION

The invention will now be described more fully hereinafter with reference to the accompanying drawings, in which certain aspects of the invention are shown. This invention may, however, be embodied in many different forms and should not be construed as limited to the embodiments and aspects set forth herein; rather, these embodiments are provided by way of example so that this disclosure will be thorough and complete, and will fully convey the scope of the invention to those skilled in the art. Like numbers refer to like elements throughout the description.

It is to be understood that the present invention is not limited to the embodiments described herein and illustrated in the drawings; rather, the skilled person will recognize that many changes and modifications may be made within the scope of the appended claims.

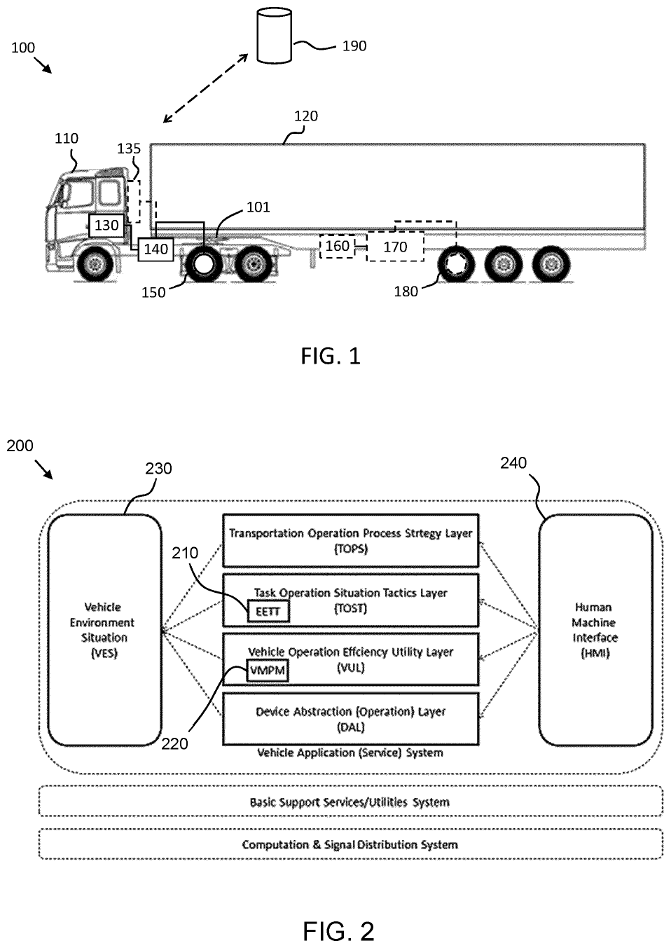

FIG. 1 illustrates a heavy-duty vehicle 100. This particular example comprises a tractor unit 110 which is arranged to tow a trailer unit 120. The tractor 110 is controlled by a vehicle control system which comprises one or more vehicle control units (VCU) 130 configured with software arranged to control various functions of the vehicle 100. For instance, the VCU (or VCUs) in the control system may be arranged to perform a vehicle motion and power management (VMPM) function comprising control of wheel slip, vehicle unit stability, and so on. The VMPM function also manages the operation of the vehicle's energy supply systems, such as the electrical storage system (ESS) on a battery powered vehicle, and/or the hydrogen tanks on a hydrogen-powered vehicle such as a fuel cell powered vehicle or a vehicle comprising a hydrogen combustion engine.

The trailer unit 120 optionally also comprises one or more VCUs 160, which then control various functions on the trailer 120. A VCU on the vehicle 100 may be communicatively coupled, e.g., via wireless link, to a remote server 190. This remote server may be arranged to perform configuration of the VCU, and to provide various forms of data to the vehicle 100. The vehicle combination 100 may of course also comprise additional vehicle units, such as a dolly unit used to connect more than one trailer unit to the vehicle combination.

An important part of this disclosure is a proposed set of interfaces between different functional modules. These interfaces allow for efficient control and data exchange between different control function in the tractor unit 110, the trailer unit 120, and in the remote server 190.

The terms energy and power will be used throughout this text. It is understood that energy and power are closely related but are not the same physical quantity. While energy, measured, e.g., in Joules (J) represents the ability to cause change in a physical system; power is the rate at which energy is moved, or used, often measured in Watts (W). The two terms will be used interchangeably herein, and the meaning will be clear from context. For instance, a storage capability of an ESS is a measure of energy, while the charging capacity of this ESS is a measure of power, i.e., how fast energy can be transferred into or out from the ESS via the ESS interface.

The example vehicle 100 may be an electrically powered vehicle, where the tractor 110 comprises one or more driven axles powered by electric machines 150, which draw electrical power from an ESS 140 on the tractor 110. This ESS normally comprises a battery pack of some sort but may also comprise a fuel cell stack 135 for the generation of electrical energy from hydrogen. The fuel cell stack is then connected to a hydrogen storage tank (not shown in FIG. 1).

The trailer unit 120 may also comprise one or more driven axles powered by electric machines 180 which draw power from a trailer ESS 170. The driven axles on the trailer 120 can be controlled from the trailer VCU 160 operating in slave mode configuration with respect to the main tractor VCU 130. Alternatively, the trailer VCU may be a stand-alone VCU which controls trailer motion independently from the tractor VCU 130, e.g., by monitoring coupling forces at the fifth wheel connection 101.

The vehicle 100 may comprise various physical interfaces for transferring energy to and from the environment, such as electrical connectors having different power ratings, i.e., maximum current levels which can be drawn into the ESS or output from the ESS. A hydrogen tank interface may also be present, allowing the vehicle to fill up one or more hydrogen storages and also to off-load hydrogen from the one or more hydrogen storages on the vehicle.

The vehicle 100 will move along a path or route through a vehicle environment. This environment comprises a number of energy suppliers or energy sources from which the vehicle 100 may draw energy, and also a number of potential energy consumers to which the vehicle 100 may off-load energy. For instance, a bus operating along a bus route may periodically pass charging stations where energy can be transferred to the bus, and where also surplus energy not deemed necessary for completing the current transportation mission can be output from the vehicle back to the energy infrastructure. Decisions about when and how much energy to take in from the energy suppliers, and also to output to the consumers must be made on a regular basis. Preferably, the vehicle 100 therefore operates according to well-balanced and thought-through energy transferring tactics setting guidelines for how this energy transfer is to be performed. Such external energy transferring tactics is a main topic of the present disclosure.

FIG. 2 shows a vehicle functionality reference architecture 200. The external energy transferring tactics (EETT) module 210 is a key part of the present disclosure and forms part of a task operation situation tactics layer. The EETT module 210 is configured to make tactical decision about if and when the ego vehicle 100 is to exchange energy with its environment, and optionally also at which power level this exchange is to take place. It will do that by monitoring and controlling a vehicle motion and power management (VMPM) module 220 based on the current vehicle environment situation, where the latter will provide information about power suppliers/consumers relevant to the vehicle at the current point in time and also at future points in time. The VMPM function 220 also controls the various energy sources on the vehicle, such as the ESS and/or fuel cell stack. This control may comprise actions such as turning on and off the fuel cell stack energy generation process, actuating relays and performing other forms of ESS control functions.

The energy transfer control systems and control architectures disclosed herein are based on a realization that the vehicle energy transfer mechanisms show a resemblance with the overall vehicle motion management systems which control how the vehicle moves and where the vehicle travels. Therefore, the present disclosure proposes a control architecture for energy transfer where the energy transfer functions have been separated into a layered control structure which coincides with a vehicle motion management control structure. Many advantages can be obtained by merging the energy transfer functions and the vehicle motion management functions on a heavy-duty vehicle. For instance, a set of compact and efficient interfaces can be designed which support both energy management functions and vehicle motion management functions.

To execute a transport mission, a transportation operation process strategy layer (TOPS) uses knowledge about the vehicle environment to perform a strategic planning of the transport mission, which may involve, e.g., route planning and other strategic considerations such as the best date or time of day to perform the transport mission. This control layer is now also tasked with a strategic planning of energy transfer, which can be determined jointly together with other strategic considerations for the transport mission. Thus, the high layer energy transfer tactics can be determined based on considerations such as route, cargo, type of vehicle, and perhaps also which countries that are to be traversed during the transport mission, where some countries may be associated with special requirements or legislation which has a bearing on the energy transfer tactics of the vehicle 100.

A task operation situation tactics (TOST) layer receives the high layer strategic decisions from the TOPS layer and makes more short-term decisions for realizing this strategy. For vehicle motion management, this more short-term strategy may involve the determination of acceleration and curvature profiles for, e.g., successfully negotiating a curve in the road, or driving up a hill. According to the present disclosure, the TOST layer comprises the EETT function 210 which considers more fine-grained information about the vehicle environment. For instance, the EETT may implement an interface for communication directly with a charging station on the side of the road, and may thus obtain information about current charging capability, energy cost, and the like. The EETT 210 then acts according to the more course-grained tactics determined by the TOPS layer functions.

The EETT 210 provides a mechanism for making strategic decisions about when and if to offer power to its environment and/or when and if to retrieve power from the vehicle environment. The EETT 210 holds software-based monitoring and controlling functionality configured to make near-term tactical decisions about how and when to transfer the right amount of energy from an external energy supplier (source) to the ego vehicle, and also how and when to transfer the right amount of energy from the ego vehicle (source) to an external energy consumer, such as electrical mains, another vehicle, or some on-board auxiliary equipment which may involve the transfer of energy to an on-board secondary ESS.

Furthermore, when transferring electricity from an electric power grid together with utilizing water from a water grid the vehicle can generate hydrogen if there are such possibilities offered by the vehicle utilities dealing with vehicle's power situation and either transfer that to an external hydrogen storage or even to the vehicle's hydrogen tanks if such are present.

When to transfer energy can also be related to the overall cost/price of the energy at certain points along an extended route, i.e. the overall productivity of the transportation process. This information is provided by the vehicle environment situation (VES) layer.

When to transfer energy in the scope of the present disclosure means at specific time slots. Thus, the EETT 210 optionally offers a service that makes it possible to set the time slots for when to operate. The EETT 210 also deals with securing that the right amount of energy is transferred at these time slots, which in turn is derived from services provided by the VMPM 220 such as the capability of the vehicle to receive a certain amount of energy and at what rate that energy can be received, i.e., the power, and also what kinds of power sources that can be interfaced to.

In some cases, when an energy transfer is ongoing, it is also important to understand that it is not appropriate to drive the vehicle and thus driving needs to be prohibited. This should of course not happen if the higher-level planning works properly, but in case of a conventional driving (“a human in front of a steering wheel”), predictions of what a human will do might fail and thus vehicle motion may need to be prevented by the control system. In other words, the control system of the vehicle may be configured to prevent vehicle motion during time periods when energy is transferred to or from the vehicle. The EETT may in such cases transmit a message to the VMPM indicating that the vehicle is to remain stationary. The VMPM may then prevent vehicle motion until, e.g., a release message is received from the EETT module 210. This type of function is conveniently implemented in the proposed architecture since vehicle motion management and energy management functions are realized in the same control stack.

When to transfer energy at specific time slots optionally also involves ensuring that there are possibilities to plug in a vehicle into a power network, e.g. either through an electrified road with overhead power lines or ground-level power lines or when a vehicle is plugged into an electric power grid when it is parked or even via an automatic hydrogen filling station.

The capabilities to receive or transmit power from/to different kinds of power sources are provided by the power/energy application programming interface (API) of the VMPM. This API will also be used to control the power reception as well as a possible power transmission operation. The EETT relies upon various APIs provided by the VES 230 to get information about power sources located nearby or along a planned route, how much power they are capable of providing, and so on.

It may be advantageous to incorporate knowledge about driver schedules and/or projected loads during an operational cycle for which the domain shall interact with transportation and planning strategies, e.g., in the form of a vehicle load vs. time array. Here, vehicle load may refer to the weight of carried cargo, and/or to a gross combination weight of the vehicle.

For vehicle motion management, the TOST layer sends motion requests down to a vehicle operation efficiency utility layer (VUL) which performs vehicle motion management by controlling various motion support devices such as friction brakes, propulsion devices and steering in a device abstraction layer (DAL). According to the present disclosure, the TOST layer also sends energy transfer requests down to the VUL, which implements a vehicle motion and power management (VMPM) function 220. This VMPM function executed the energy transfer requests by, e.g., closing and operating electrical relays, controls temperatures and other properties of the electrical components on the vehicle, and so on. The VMPM function 220 operates with a time horizon of about 1-5 seconds or so, and continuously transforms the acceleration profiles and curvature profiles into control commands for controlling vehicle motion functions, actuated by the different motion support devices (MSDs) of the vehicle 100 which report back capabilities to the VMPM. The MSDs are part of a device abstraction layer as shown in FIG. 2.

To summarize, there is disclosed herein a layered control architecture for controlling vehicle energy transfer according to a determined higher layer tactic. The energy transfer to and from the vehicle is organized in the same way as the overall vehicle motion management is and makes use of the information related to vehicle environment in much the same way as the vehicle motion management. It has been found that this type of layered control architecture allows for an efficient and robust energy transfer management.

The control systems discussed herein may be implemented at least in part as a module in an on-board computer on the vehicle 100, such as one or both of the VCUs 130, 160, and/or as a module in an off-board computer located externally from the vehicle 100, such as the remote server 190.

The architecture 200 also comprises a human machine interface part 240. Desired acceleration profiles and curvature profiles for operating the vehicle 100 may thus be determined based on input from a driver via this human machine interface 240, e.g., via control input devices such as a steering wheel, accelerator pedal and brake pedal. However, the techniques disclosed herein are just as applicable with autonomous or semi-autonomous vehicles as with vehicles comprising a driver. The exact methods used for determining the acceleration profiles and curvature profiles is not within scope of the present disclosure and will therefore not be discussed in more detail herein.

The EETT 210 may also involve monitoring, i.e. detection, of unwanted transferring of energy out of the vehicle, including both gaseous, fossil- and electric energy. I.e., the control system is optionally arranged to detect an unwanted and/or unauthorized transfer of energy to or from the vehicle 100. In order to do that it can make use of current power consumption status, provided by the power/energy API of the VMPM, where a current power consumption status may be an aggregated value based tank levels and changes in ESS state of charge (SOC) compared to, e.g., an expected level of power consumption. In case an unauthorized energy transfer (theft) is detected, this EETT may trigger a report of the event, e.g., to an on-board HMI device or to an external device like a mobile phone or security system, and also if technically possible try to stop the unauthorized transfer.

An unwanted transfer of energy can be detected by comparing a current energy transfer to the higher layer energy transfer strategy. If a transfer of energy is not in line with the strategy, then an unwanted transfer can be detected.

The unwanted and/or unauthorized transfer of energy may be a transfer of energy away from the vehicle. Such transfer may involve energy theft which can then be detected and reported to the authorities, or even prevented by locking down energy transfer capabilities of the vehicle. However, the unwanted and/or unauthorized transfer of energy may also involve transfer of energy to the vehicle. For instance, a driver may have an option to transfer more expensive energy in a convenient manner compared to an option of energy transfer involving a reduced cost. An operator may then use this function to detect if a driver regularly selects an energy source which is not in line with the operator's instruction. An operator may also assign a cost of energy determined in dependence of an environmental impact, and make sure that drivers abode by this environmental policy by transferring environmentally friendly energy to the vehicle whenever possible. This way, a driver which selects an energy source associated with higher environmental impact just because it is more convenient can be notified by the operator that he is acting in contradiction o company policy. Educational efforts for training the driver can also be triggered is this type of unwanted transfer of energy is detected by the control system.

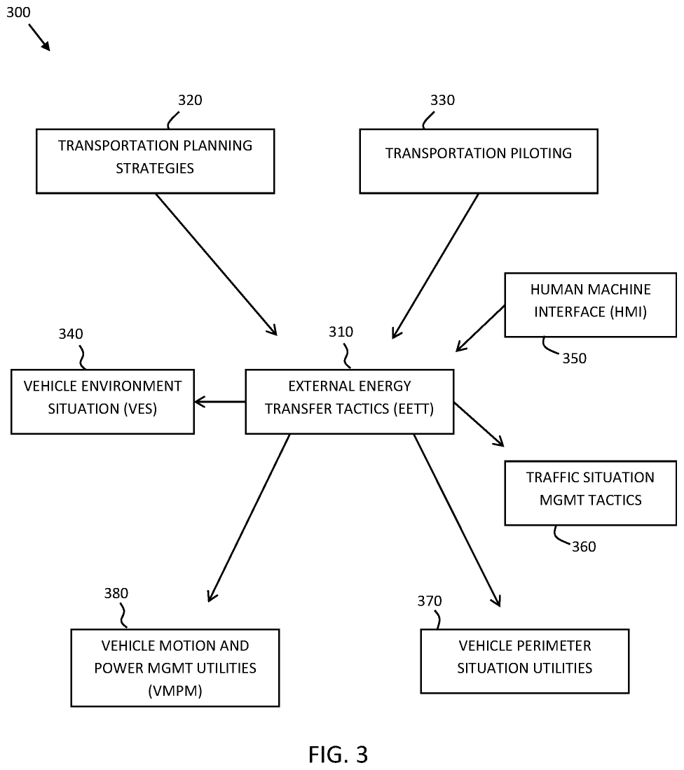

FIG. 3 illustrates the EETT functionality domain 210 in relation to other domains in the vehicle control architecture 300.

The transportation planning strategies functionality domain 320 comprises documentation related to transportation planning, such as planned routes, cargos, and the like, as well as documentation related to transport orders and transportation mission management. The transportation planning strategies may furthermore comprise information related to itinerary planning, i.e., time slots for when the transportation is to be carried out. The transportation planning strategies functionality domain 320 uses the EETT 310 for obtaining information regarding current energy transferring capabilities and vehicle status information.

The transportation piloting functionality domain 330 performs support function to execute the transport mission. The transportation piloting functionality domain 330 uses the EETT 310 for vehicle control purposes.

The vehicle environment situations functionality domain 340 comprises information related to localization and environment perception. The EETT 310 uses this functionality domain for obtaining, e.g., status information related to infrastructure power supplies.

The human machine interface functionality domain 350 relates to various aspects of HMIs on the vehicle. It uses the EETT 310 for obtaining human accessible status information and controls in the system 300.

The traffic situation management tactics functionality domain 360 provides information related to traffic environment observations, driving situation tactics, and traffic situation predictions. This functionality domain is used by the EETT 310 for obtaining driving operating status information.

The vehicle perimeter situation utilities functionality domain 370 relates to functions such as cab tilting, fire and gas utilities, illegal intrusion utilities, perimeter authentication, and also vehicle perimeter access situation. The EETT 310 uses this functionality domain to obtain information related to the status of the intrusion perimeter situation.

The vehicle motion and power management (VMPM) utilities 480 is used by the EETT 310 to obtain information related to, e.g., vehicle structure, vehicle power situation management, vehicle motion management situation and vehicle payload situation. It is used by the EETT 310 for purposes such as obtaining status and capabilities related to the vehicle, and also

[symbol]

To summarize some of the above discussions, there is disclosed herein a control system for controlling a heavy-duty vehicle 100 which is executed on one or more control units 130, 160, 190. The control system is arranged to obtain information about an energy transfer and/or power transfer capability of the vehicle 100. This energy transfer and/or power transfer capability of the vehicle may, e.g., relate to a state of charge (SOC) with respect to full charge of an on-board vehicle ESS, where the energy transfer capability is determined at least in part as a function of the ESS SOC. The energy transfer and/or power transfer capability of the vehicle may also relate to a fill level of a hydrogen tank on the vehicle 100. A vehicle may also comprise both an ESS and a hydrogen tank for driving a fuel cell stack.

The control system is also arranged to obtain information related to a transport mission of the vehicle, such as a planned route, cargo load, and the like. The transport mission may be an ongoing transport mission, i.e., a transport mission which the vehicle is currently executing. The transport mission may also be an upcoming, or planned, transport mission, i.e., a transport mission which the vehicle has not yet started to execute. The control system is furthermore arranged to obtain information related to one or more power sources and/or one or more power consumers in the vehicle environment. This means that the vehicle forms a picture of its surroundings comprising information about potential opportunities to transfer energy to the vehicle from an energy source, and also from the vehicle to an energy consumer.

In order to control energy transfer in an efficient manner, the control system 130, 160, 190 is arranged to determine tactics for when to transfer energy to or from the vehicle 100 in dependence of the energy transfer capability of the vehicle 100, the upcoming transport mission, and the one or more power sources and/or one or more power consumers in the vehicle environment, where the tactics are determined under a constraint to fulfil the upcoming transport mission. Given these tactics, the control system 130, 160, 190 then triggers transfer of energy to or from the one or more power sources and/or the one or more power consumers in the vehicle environment in accordance with the determined tactics.

Advantageously, as mentioned above, the control system is optionally arranged to perform vehicle motion management jointly with the energy management of the vehicle. Also, optionally, the control system comprises an interface configured to support joint vehicle motion management and vehicle energy management.

The information related to the transport mission optionally comprises any of a driving schedule, a transportation order, and/or an itinerary. The vehicle control software is then able to form an opinion or estimate of the amount of energy which is required to complete the transport mission. According to other aspects, the information related to the upcoming transport mission comprises information related to a projected load of the vehicle as function of time. The vehicle load is likely to impact the energy consumption of a vehicle. The more heavily laden the vehicle gets the more energy is required to complete a given transportation mission. Thus, if the vehicle expects to be heavily loaded at an upcoming point in time, then a strategy which comprises maximizing an energy storage state may be desired. Also, if the vehicle expects no heavy load, it may instead decide to follow a strategy which comprises not taking on a full charge. This may, e.g., save some time at a stop, which may be desired.

With reference to FIG. 8, the information related to the upcoming transport mission comprises information related a road property, such as a level a of descent or ascent. FIG. 8 illustrates some examples of use-cases 810, 820 which a vehicle 800 must be able to support. The use-case 810 is an uphill driving use-case, where the vehicle must be able to generate sufficient torque to overcome gravitational pull as well as friction losses for the duration of the uphill drive. The use-case 820 is instead a downhill driving scenario where braking is required if the vehicle should not exceed its maximum allowable vehicle speed.

The vehicle must be able to maintain a vehicle velocity below a configured maximum vehicle velocity for the duration of the downhill drive, which may require endurance braking. The different use-cases 810, 820 imply peak torque requirements, both with respect to positive as well as negative torque, which must be met by the combination of torque generating devices on the vehicle including any electric machines.

The longitudinal force F_{x,reg} in, e.g., Newton (N), required to be generated by the vehicle 800 can be approximated as

$${F}_{x , r e q} = {m}_{GCW} {a}_{x , r e q} + 0.5 {C}_{d} {A}_{f} {ρ}_{a i r} {v}_{x}^{2} + g {C}_{r} {m}_{GCW} + {m}_{GCW} g sin ( \frac{s}{100} ) )$$

where m_{GCW} is the vehicle gross combination weight, a_{x,reg} is the required acceleration by the vehicle, C_{d}A_{f} is the product of air drag coefficient C_{d} and vehicle front area A_{f}, ρₐᵢᵣ represents air density, vₓ is the vehicle speed, g is the gravitational constant, Cᵣ is rolling resistance, and s is a slope percentage value between 0 and 100. The output energy from the one or more electric machines on the different vehicle units for a given route can be predicted from a relationship like that above. For instance, suppose that the vehicle is required to be able to travel down a hill having a slope of, say s=20 for a certain distance. Given the maximum allowable velocity vₓ^{max} the required braking torque can be determined from the above relationship. Given the expected time duration for the down-hill travel, and the required negative torque, an expected amount of generated energy from regenerative braking can be determined. If the route height profile is known, e.g., by the transport mission and route planning function 220 discussed in connection to FIG. 2, then a desired energy absorption capability of the vehicle unit can be determined rather accurately. However, if the route data is not known, then assumptions on braking requirements can be made, and the desired energy absorption capability can be determined from the assumptions. The assumptions may be related to an operational design domain (ODD) of the vehicle unit.

According to other aspects, the information related to the one or more power sources and/or the one or more power consumers in the vehicle environment comprises a cost associated with the transferred energy. Thus, it is appreciated that the tactics for transferring energy to and from the energy may involve cost considerations. For instance, the vehicle 100 may be configured to evaluate different options for replenishing an energy storage along a planned route in terms of the involved cost. The cost metric may indicate different types of cost, not only monetary cost. Other possible cost metrics comprise predicted environmental impact, e.g., in terms of emitted carbon dioxide, a time spent during certain activities or a predicted time for completing a transport mission. Thus, the EETT may involve considerations which comprise an estimated time to replenish an energy source. For example, one energy source which is located a bit off from a planned route or at some distance from a cargo terminal may have a high capacity in terms of power, while another energy source more close to the planned route has a lower power transfer capability. A preferred energy transfer tactic may then comprise visiting the off-route energy source, since the overall time spent on the transportation mission may be shorter. Optionally, a joint cost metric comprising both monetary cost and time spent may be designed. A good tactic in such cases is one which strikes a balance between time and money spent.

According to other aspects, the control system is arranged to prepare a fuel cell system 135 of the vehicle 100, 800 for freezing. Such preparation may, e.g., comprise flushing the fuel cell system if the vehicle is in a location suitable for flushing the fuel cell system. It is understood that a fuel cell system may need to be flushed, i.e., emptied from liquid and other liquids in preparation for freezing. This could, e.g., be the case if the vehicle 100 is to be parked for a longer duration of time in an environment where average temperatures is below zero. It may not be desired to perform such flushing in, e.g., a confined space like a parking garage or the like. However, since the control systems discussed herein keep track of vehicle location, and may maintain a set of criteria which are indicative of a location where this type of fuel cell flushing can be performed, the flushing can be performed at a suitable time and in a suitable location, which is an advantage.

A risk for freezing can be determined based on a weather report or the like.

The control system can also be configured to report a current energy transfer capability of the vehicle and/or a set of energy types which can be transferred to and from the vehicle, in response to a request from an external entity. This means that different external entities can request information from the vehicle and thus gain information about the capabilities of the vehicle in terms of energy transfer. For example, a vehicle which is running dangerously low in energy level may poll other vehicles nearby to see if some vehicle has a surplus energy store of a given type, and can then request transfer of an amount of energy to at least partly replenish its energy store.

The different vehicle control systems 130, 160, 190 discussed herein may also implement an application programming interface (API) configured to allow connections from one or more external entities. The control system is then configured to determine an available amount of energy for transfer from the vehicle 100, 800 to an external consumer, and/or a desired amount of energy to transfer to the vehicle 100, 800 from an external energy source. The control system is configured to exchange information related to the available amount of energy for transfer from the vehicle 100, 800 via the API, and also to exchange information related to the available amount of energy for transfer to the vehicle 100, 800 via the API.

As mentioned above, an important part of the present disclosure is the realization that the type of layered control architecture used to control vehicle motion according to high layer more long-term strategies which are then realized by lower layer control functions which execute strategies on smaller time scales, can be used also for vehicle energy transfer. This, however, requires a new set of interfaces which are able to support both vehicle motion requests and capability information reports as well as requests and capability information reports related to energy transfer.

Thus, there is disclosed herein an API configured to transfer information related to vehicle motion management, involving, e.g., acceleration requests and curvature requests, jointly with information related to vehicle energy transfer, such as power levels and time durations.

There is furthermore disclosed herein an API configured to transfer low level MSD control commands such as target torques and steering angles jointly with energy transfer commands such as requests for actuating electrical relays and the like which controls energy transfer to or from the vehicle. This API will then also be able to support capability reporting from the different devices configured to support energy transfer to the different control units involved in the energy transfer.

The control system is optionally configured to maintain a list of energy types available for transfer to and/or from the vehicle 100, 800, and to exchange information related to the energy types via the API. Thus, a software module executing on-board the vehicle or executing external to the vehicle may access the control system via the API and thus obtain information related to the energy types relevant for energy transfer involving the vehicle.

The control system may also be configured to transmit a request for transfer of energy to the vehicle 100, 800 via the API. Thus, a vehicle at an energy source location, or a vehicle approaching an energy source location, may use the API to submit a request for energy transfer. The energy source may then communicate via the API with the vehicle in order to facilitate the energy transfer. This communication may, e.g., comprise transmitting and receiving various configuration parameters such as power rating and the like, as well as an estimated cost of energy transfer and time spent for transferring a given amount of energy.

According to other aspects, the control system 130, 160, 190 is also configured to exchange information related to an energy transferring capability and/or energy transferring status with a transportation planning function via the API. Thus, the transportation planning function may interface with the control system via the API in order to exchange information related to an energy transferring capability and/or energy transferring status. Information related to location and type of power suppliers in the infrastructure may of course also be exchanged via the API.

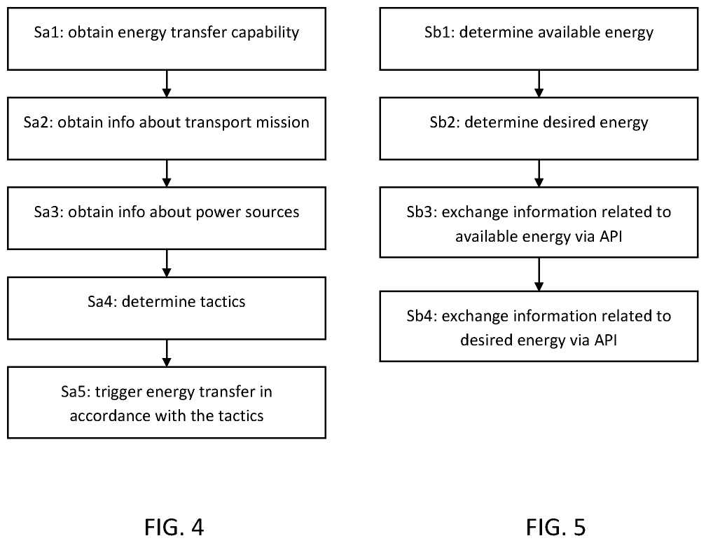

FIGS. 4 and 5 are flow charts illustrating example methods which describe some of the techniques discussed herein. It is appreciated that many of the different aspects and optional features can be added to the methods with additional advantages as a result.

The techniques described herein may also be formulated as methods. FIG. 4 shows one such method, performed in a vehicle control system 130, 160, 190, for determining energy transfer tactics by a heavy-duty vehicle 100, 800. The method comprises obtaining Sa1 information about an energy transfer capability of the vehicle 100, 800, obtaining Sa2 information related to an upcoming transport mission, obtaining Sa3 information related to one or more power sources and/or one or more power consumers in the vehicle environment, determining Sa4 tactics for when to transfer energy to or from the vehicle 100, 800 in dependence of the energy transfer capability of the vehicle 100, 800, the upcoming transport mission, and the one or more power sources and/or one or more power consumers in the vehicle environment, where the tactics are determined under a constraint to fulfil the upcoming transport mission, and triggering Sa5 transfer of energy to or from the one or more power sources and/or the one or more power consumers in the vehicle environment in accordance with the determined tactics.

FIG. 5 shows another such method, performed in a control system 130, 160, 190, for controlling transfer of energy to and from a heavy-duty vehicle 100, 800, wherein the control system implements an API configured to allow connections from one or more external entities. The method comprises determining Sb1 an available amount of energy for transfer from the vehicle 100, 800 to an external consumer, determining Sb2 a desired amount of energy for transfer to the vehicle 100, 800 from an external energy source, exchanging Sb3 information related to the available amount of energy for transfer from the vehicle 100, 800 via the API, and exchanging Sb4 information related to the available amount of energy for transfer to the vehicle 100, 800 via the API.

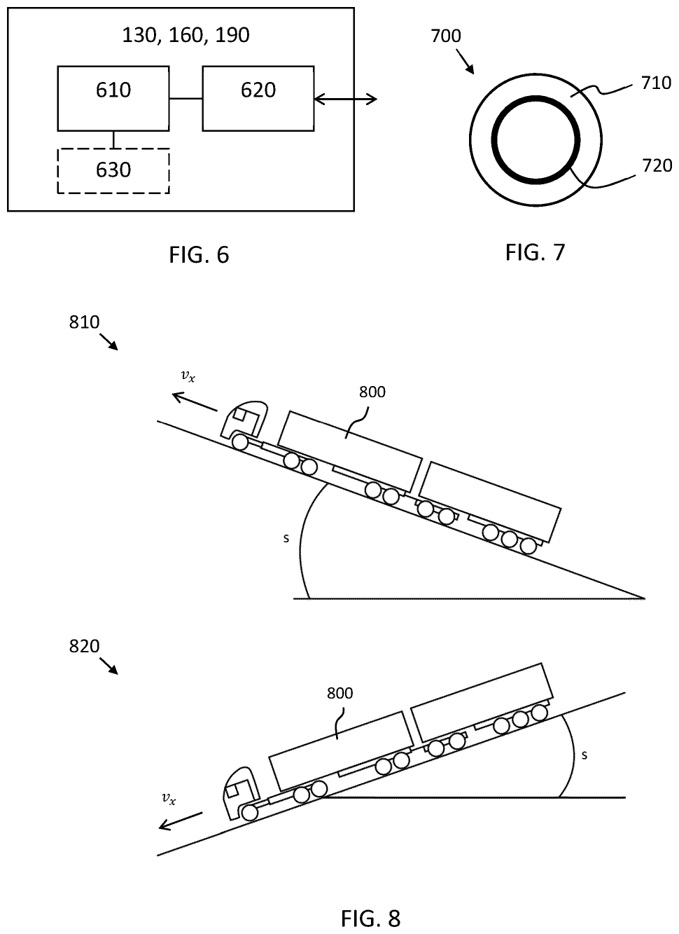

FIG. 6 schematically illustrates, in terms of a number of functional units, the components of a control unit implementing part of or an entire control system according to embodiments of the discussions herein, such as any of the VUCs 130, 160 or the remote server 190. This control unit may be comprised in the vehicle 100. Processing circuitry 610 is provided using any combination of one or more of a suitable central processing unit CPU, multiprocessor, microcontroller, digital signal processor DSP, etc., capable of executing software instructions stored in a computer program product, e.g. in the form of a storage medium 630. The processing circuitry 610 may further be provided as at least one application specific integrated circuit ASIC, or field programmable gate array FPGA.

Particularly, the processing circuitry 610 is configured to cause the control unit to perform a set of operations, or steps, such as the methods discussed in connection to FIG. 4 and/or FIG. 5. For example, the storage medium 630 may store the set of operations, and the processing circuitry 610 may be configured to retrieve the set of operations from the storage medium 630 to cause the control unit to perform the set of operations. The set of operations may be provided as a set of executable instructions. Thus, the processing circuitry 610 is thereby arranged to execute methods as herein disclosed.

The storage medium 630 may also comprise persistent storage, which, for example, can be any single one or combination of magnetic memory, optical memory, solid state memory or even remotely mounted memory.

The control unit may further comprise an interface 620 for communications with at least one external device. As such the interface 620 may comprise one or more transmitters and receivers, comprising analogue and digital components and a suitable number of ports for wireline or wireless communication.

The processing circuitry 610 controls the general operation of the control unit, e.g., by sending data and control signals to the interface 620 and the storage medium 630, by receiving data and reports from the interface 620, and by retrieving data and instructions from the storage medium 630. Other components, as well as the related functionality, of the control node are omitted in order not to obscure the concepts presented herein.

FIG. 7 illustrates a computer readable medium 710 carrying a computer program comprising program code means 720 for performing the methods illustrated in FIGS. 6A-C, when said program product is run on a computer. The computer readable medium and the code means may together form a computer program product 700.

1.-17. (canceled)

18. A control system arranged to control transfer of energy to and from a heavy-duty vehicle, wherein the control system implements an application programming interface, API, configured to allow connections between control modules of the heavy-duty vehicle and/or from one or more external entities to the vehicle
wherein the control system is configured to determine an available amount of energy for transfer from the vehicle to an external consumer, and/or a desired amount of energy to transfer to the vehicle from an external energy source,
wherein the control system is configured to exchange information related to the available amount of energy for transfer from the vehicle via the API,
wherein the control system is configured to exchange information related to the available amount of energy for transfer to the vehicle via the API, and
wherein the control system is arranged to detect an unwanted and/or unauthorized transfer of energy to or from the vehicle, and to trigger transmission of a message indicating the unwanted and/or unauthorized transfer of energy via the API.

19. The control system according to claim 18, wherein the API is arranged to support vehicle motion management control jointly with the control of transfer of energy to and from a heavy-duty vehicle.

20. The control system according to claim 18, configured to maintain a list of energy types available for transfer to and/or from the vehicle, and to exchange information related to the energy types via the API.

21. The control system according to claim 18, configured to transmit a request for transfer of energy to the vehicle via the API.

22. The control system according to claim 18, configured to exchange information related to a cost of energy via the API.

23. The control system according to claim 18, configured to exchange information related to an energy transferring capability and/or energy transferring status with a transportation planning function via the API.

24. The control system according to claim 18, configured to exchange information related to location and type of power suppliers in an infrastructure via the API.

25. The control system according to claim 18, wherein the control system is arranged to
obtain information about an energy transfer capability of the vehicle,
obtain information related to an upcoming transport mission,
obtain information related to one or more power sources and/or one or more power consumers in a vehicle environment,
wherein the control system is arranged to determine tactics for when to transfer energy to or from the vehicle in dependence of the energy transfer capability of the vehicle, the upcoming transport mission, and the one or more power sources and/or one or more power consumers in the vehicle environment, where the tactics are determined under a constraint to fulfil the upcoming transport mission, and
wherein the control system is arranged to exchange the determined tactics with an external entity via the API.

26. The control system according to claim 18, comprised at least in part as a module in an on-board computer on the vehicle.

27. The control system according to claim 18, comprised at least in part as a module in an off-board computer located externally from the vehicle.

28. The control system according to claim 18, wherein the API is configured to support transfer of information related to vehicle motion management jointly with transfer of information related to energy transfer.

29. A vehicle comprising the control system according to claim 18.

30. A method, performed in a control system, for controlling transfer of energy to and from a heavy-duty vehicle, wherein the control system implements an application programming interface, API, configured to allow connections from one or more external entities, the method comprising
determining an available amount of energy for transfer from the vehicle to an external consumer,
determining a desired amount of energy for transfer to the vehicle from an external energy source,
exchanging information related to the available amount of energy for transfer from the vehicle via the API,
exchanging information related to the available amount of energy for transfer to the vehicle via the API,
detecting an unwanted and/or unauthorized transfer of energy to or from the vehicle, and
triggering transmission of a message indicating the unwanted and/or unauthorized transfer of energy via the API.

31. A computer program comprising program code for performing the method of claim 30 when said program is run on a computer or on processing circuitry of a control system.
